(19) United States
(12) Patent Application Publication
(10) Pub. No.: US 2002/0023538 A1
(43) Pub. Date: Feb. 28, 2002

(54) System for recovery of sulfur and hydrogen from sour gas

(76) Inventors: Pradeep K. Agarwal, Laramie, WY (US); Temi M. Linjewile, Murray, UT (US); Ashley S. Hull, Saint Charles, MO (US)

Correspondence Address: EMERY L. TRACY, P.O. Box 1518, Boulder, CO, 80306, US

(21) Appl. No.: 09/960,659

(22) Filed: Sep. 21, 2001

Related U.S. Application Data
(60) Provisional application No. 60/125,962, filed on Mar. 24, 1999.

(30) Foreign Application Priority Data
Mar. 23, 2000 (US) PCT/US00/07753

(51) Int. Cl. B01D 53/12

(52) U.S. Cl. 95/108; 95/136; 96/123; 96/150

(57) ABSTRACT

A device for removing contaminants from a natural gas stream is provided. The device comprises a first adsorbent positioned within a first fluidized bed operating at a first predetermined temperature for removing at least a portion of the contaminants from the natural gas stream and creating a partially sweetened natural gas stream. A second adsorbent is positioned within a second fluidized bed operating at a second predetermined temperature for receiving the partially sweetened natural gas stream with the second adsorbent removing at least a portion of the contaminants from the partially sweetened natural gas stream. Furthermore, a conversion apparatus can be provided for converting H₂S within the removed contaminants to elemental sulfur and hydrogen at a third predetermined temperature.

The present application is a continuation of pending provisional patent application Serial No. 60/125,962, filed on Mar. 24, 1999, entitled “System For Recovery Of Sulfur And Hydrogen From Sour Gas Using A Plasma Reactor”.

### BACKGROUND OF THE INVENTION

1. Field of the Invention

This invention relates generally to a process for removal of hydrogen sulfide from a gaseous stream and the subsequent recovery of hydrogen and sulfur from the hydrogen sulfide and, more particularly, it relates to removal of H₂S , CO₂, and H₂O from a sour natural gas stream in a fluidized bed adsorber followed by the conversion of H₂S to elemental sulfur and hydrogen in a corona reactor.

2. Description of the Prior Art

The proven reserves of natural gas in the United States are of the order of 170 trillion cubic feet; taking data from various exploration programs into account, the natural gas resource base may be inferred to be close to 1118 trillion cubic feet. About twenty (20) trillion cubic feet of the proven reserves of natural gas contain significant amounts of H₂S, CO₂, and H₂O and other sulfur-containing contaminants. The sulfur must be removed form such streams to enable users to comply with environmental regulations. Moisture removal is necessary since the presence of moisture leads to the formation of hydrates, which through increasing the pressure drop along the transmission pipeline, decrease transmission capacity. CO₂ is an undesirable diluting gas, which lowers the heating value of natural gas. Presence of moisture and H₂S is also a major factor in corrosion of equipment.

Processes for removal of H₂S from a gas stream are based on two principal mechanisms: absorption by regenerable solvents and adsorption on a bed of solids. Processes based on absorption often involve the use of one of the several amine solutions such as monethanolamine, diethanolamine, and triethanolamine, followed by thermal regeneration of the solvent to recover acid gases and the amine solution.

Most adsorption processes employ fixed beds, but moving and fluidized beds are also used. Adsorbent materials for H₂S removal include molecular sieves, iron oxide, zinc oxide, zinc titanate, tin oxide, and zinc ferrite. Molecular sieves have excellent selective mercaptan. Since molecular sieves are designed to strongly attract and retain specific gas components, they are well suited for thermal-swing regeneration in a temperature swing adsorption cycle. Regeneration produces an enriched stream of the adsorbate and a revitalized sorbent for reuse.

Conversion of hydrogen sulfide to recover sulfur is often accomplished via the Claus process. The Claus process was invented in 1883 by Carl Friedrich Claus, a London Chemist, and was put into industrial-scale operation in the 1950's in the United States. A typical Claus sulfur-recovery plant consists of two major process stages. Stage one consists of a combustion furnace, waste heat boiler, and a sulfur condenser. Stage two is comprised of a series of catalytic converters numbering between one and four units. Each of the catalytic converters is equipped with a re-heating unit, catalyst bed, and a sulfur condenser. Hydrogen sulfide is converted to sulfur in the Claus process by two principal reactions: combustion of part of the hydrogen sulfide to sulfur dioxide and subsequent reaction of sulfur dioxide with hydrogen sulfide over a catalyst to produce sulfur and water.

2H₂S+30₂→2SO₂+2H₂O (1)

2H₂S+SO₂→3S+2H₂O (2)

Sulfur recovery up to 97% is achievable by employing multiple catalytic converters.

Conversion of H₂S to elemental sulfur can also be achieved by dissociation of H₂S by energetic electrons. This can be implemented by employing a number of nonthermal plasma processes, which include corona, dielectric barrier, microwave, and radio-frequency discharges. In a pulsed corona reactor, high-voltage pulses produce short-lived microdischarges, which preferentially accelerate the electrons without imparting significant energy to the ions. This results in improvement in power consumption and energy saving potential. In addition, since most of the energy applied goes to accelerating the electrons rather than the massive ions, larger reactor volumes are possible because the high energy electrons are capable of filling larger volumes.

Existing methods for removal of H₂S by adsorption use fixed bed technology. Fixed beds suffer from the inherent problem of slow response to changes in gas temperature. By comparison, fluidized-bed adsorption processes offer excellent gas-solid contact, fast kinetics, and steady operation. However, stresses induced by rapid temperature swings and fluidization have hampered efforts to use fluidized beds for adsorption.

Most industrial sulfur recovery processes are based on the Claus process, which entails partial combustion of H₂S stripped from the natural gas stream to form SO₂, Reaction (1). Elemental sulfur is recovered by the reaction of the remaining H₂S with SO₂as shown in Reaction (2). Thermodynamic constraints of Reaction (2) limit the conversion of H₂S in a single stage catalytic converter (to about 0.7) and, hence, the thermal recovery of elemental sulfur from the Claus furnace (operated at around 2400° F.). In order to increase the efficiency of sulfur recovery, the effluent gases from the Claus furnace are cooled to recover sulfur and then contacted over a number of packed-bed catalytic converters at lower temperatures. Depending on the number of stages employed, recovery efficiencies vary between 90% and 98%. For optimum operation, the composition of the gases in the Claus process must be maintained such that the H₂S/SO₂ ratio is 2:1. Even after several conversion stages, 2000-3000 ppm of H₂S and SO₂ may remain in the effluent gas from the Claus process, posing environmental compliance problems, Customarily, an additional tailgas cleanup unit is employed to ensure that the final overall sulfur recovery exceeds 99%. Two such processes for tailgas cleanup are the Shell Claus off-gas treatment (SCOT) process and the Superclaus process. The SCOT tailgas cleanup process is the most widely used. However, an “add-on” SCOT plant may cost as much as the parent Claus plant itself.

Alternatively, a Superclaus unit may be introduced as the last stage in the series of catalytic converters. The process is based on selective oxidation of the unconverted H₂S to elemental sulfur, in the presence of a catalyst. Although both SCOT and Superclaus processes can improve sulfur recovery efficiency, the cost of installation of plant may not be offset by the sulfur recovered. Moreover, both processes fail to recover hydrogen, a valuable resource that may improve the overall economics of sulfur removal.

The mechanism of electron-impact assisted dissociation of H₂S occurs according to the following reactions:

H₂S⇄H+SH⇄2H+S (3)

2H⇄H₂ (4)

nS ⇄Sn (5)

Unstable atomic sulfur and hydrogen formed in reaction (3), recombine to stable H₂ and S as shown in reactions (4) and (5). In an electrical discharge reactor, the reactivation of H₂ and S leads to reformation of H₂S. This has an impact on the conversion and energy efficiency of the process.

### SUMMARY

The present invention is a device for removing contaminants from a natural gas stream. The device comprises first adsorbent means positioned within a first fluidized bed operating at a first predetermined temperature for removing at least a portion of the contaminants from the natural gas stream and creating a partially sweetened natural gas stream. Second adsorbent means are positioned within a second fluidized bed operating at a second predetermined temperature for receiving the partially sweetened natural gas stream with the second adsorbent means removing at least a portion of the contaminants from the partially sweetened natural gas stream.

In an embodiment of the present invention, the contaminants are selected from the group consisting of H₂S, CO₂, and H₂O. Furthermore, preferably, the first adsorbent means is a molecular sieve and the second adsorbent means is a molecular sieve.

In another embodiment of the present invention, the first predetermined temperature is greater than the second predetermined temperature. Preferably, the first predetermined temperature is between approximately twenty (20°) degrees C. and approximately sixty (60°) degrees C. and the second predetermined temperature is between approximately one hundred (100°) degrees C. and approximately three hundred (300°) degrees C.

In still another embodiment of the present invention, the device further comprises conversion means for converting H₂S within the removed contaminants to elemental sulfur and hydrogen at a predetermined temperature less than approximately four hundred (400°) degrees C. Preferably, conversion means is a nonthermal plasma corona reactor.

The present invention additionally includes an apparatus for converting H₂S to elemental sulfur and hydrogen. The apparatus comprises conversion means for receiving H₂S and for converting H₂S to elemental sulfur and hydrogen at a predetermined temperature less than approximately four hundred (400°) degrees C.

In an embodiment of the present invention, the conversion means is a nonthermal plasma corona reactor.

In still another embodiment of the present invention, the apparatus further comprises adsorbent means positioned within a fluidized bed for removing at least a portion of H₂S from a natural gas stream and means for providing the removed H₂S to the conversion means.

In yet another embodiment of the present invention, the adsorbent means includes a first adsorbent having a first predetermined temperature and second adsorbent having a second predetermined temperature. Preferably, the first adsorbent means and the second adsorbent means are molecular sieves. Furthermore, preferably, the first predetermined temperature is greater than the second predetermined temperature.

The present invention further includes a method for removing H₂S and other contaminants from a natural gas stream and converting H₂S to elemental sulfur and hydrogen. The method comprises providing a first adsorbent, positioning the first adsorbent within a fluidized bed at a first predetermined temperature, introducing the natural gas stream to the first adsorbent thereby removing at least a portion of the H₂S and other contaminants from the natural gas stream and creating a partially sweetened natural gas stream, providing a second adsorbent, positioning the second adsorbent within a fluidized bed at a second predetermined temperature, introducing the partially sweetened natural gas stream to the second adsorbent thereby removing at least a portion of the contaminants from the partially sweetened natural gas stream, providing a nonthermal plasma reactor, introducing the removed contaminants to the nonthermal plasma reactor, and converting the H₂S to elemental sulfur and hydrogen at a third predetermined temperature.

In an embodiment of the present invention, the first adsorbent means and the second absorbent means are molecular sieves. Preferably, the first predetermined temperature is greater than the second predetermined temperature with the first predetermined temperature being between approximately twenty (20°) degrees C. and approximately sixty (60°) degrees C. and the second predetermined temperature being between approximately one hundred (100°) degrees C. and approximately three hundred (300°) degrees C. Furthermore, preferably, the third predetermined temperature being less than approximately four hundred (400°) degrees C.

### BRIEF DESCRIPTION OF THE DRAWINGS

FIG. 1 is a perspective view illustrating a system for recovery of sulfur and hydrogen from sour gas, constructed in accordance with the present invention, including (1) removal of H₂S, CO₂, and H₂O from a sour natural gas stream and sorbent regeneration and (2) conversion of H₂S to elemental sulfur and hydrogen in a corona reactor, and

FIG. 2 is a schematic diagram illustrating the process for (1) removal of H₂S, CO₂, and H₂O from a sour natural gas stream and sorbent regeneration and (2) conversion of H₂S to elemental sulfur and hydrogen in a corona reactor, constructed in accordance with the present invention.

### DETAILED DESCRIPTION OF THE PREFERRED EMBODIMENTS

As can be understood by those persons skilled in the art, the basic concepts of the present invention can be embodied in a variety of ways. The present invention involves both processes and devices to accomplish the improved processes. In the present application, the processes are discussed in detail. Systems and devices to be established under the invention are described as items inherent to utilization of such processes. To the extent some devices are disclosed, it should be understood that these not only accomplish certain methods, but also can be varied in a number of ways. Importantly, as to all of the foregoing, all of these facets should be understood to be encompassed by the disclosure herein.

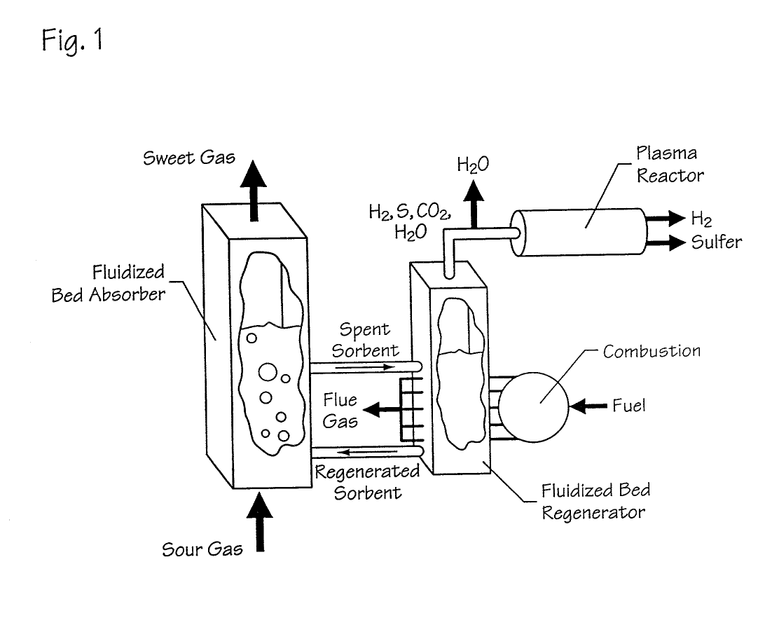

As illustrated in FIG. 1, the present invention comprises the removal of H₂S, CO₂, H₂O, and other sulfur-containing contaminants from natural gas streams employing a fluidized bed adsorber and recovery of elemental sulfur and hydrogen in a corona reactor at low temperatures, preferably less than approximately four hundred (400°) degrees C. The process consists of two steps. The first step is the removal of H₂S, CO₂, and H₂O from a sour natural gas stream and sorbent regeneration. This step is accomplished using the concept of temperature swing adsorption. The contaminants in the natural gas are adsorbed on molecular sieves in fluidized beds operated at low temperatures, preferably between approximately twenty (20°) degrees C. and approximately sixty (60°) degrees C. The spent sorbent is circulated to a high temperature, preferably between approximately one hundred (100°) degrees C. and approximately three hundred (300°) degrees C., fluidized bed regenerator and the gas stripped from the sorbent in the regenerator is used for sulfur and hydrogen recovery.

The second step is the conversion of H₂S to elemental sulfur and hydrogen in a corona reactor at a temperature less than approximately four hundred (400°) degrees C. The H₂S, CO₂, and CH₄ from the regenerator will form the primary feed to a corona reactor. Recovery of elemental sulfur and hydrogen from H₂S in a nonthermral plasma reactor is based, primarily, on the following reactions:

H₂S⇄H+SH (6)

H+SH⇄2H+S (7)

2H⇄H₂ (8)

H₂S+H⇄SH+H₂(9)

The emphasis is on the dissociation of H₂S according to Reaction (6). Formation of sulfur occurs by Reaction (7). Reactions (8) and (9) are responsible for formation of hydrogen. Since the feed gas stream to the corona reactor consists of H₂S and CO₂, the following reaction can also take place:

H₂S+CO₂⇄H₂O+CO+S (10).

The approach herein has a distinct advantage in that the fuel value of H₂S is transformed to CO and H₂; this synthesis gas can actually be burnt to meet the energy requirements of the process. While CO₂ also leads to the formation of COS, its production can be minimized by choice of proper operating conditions.

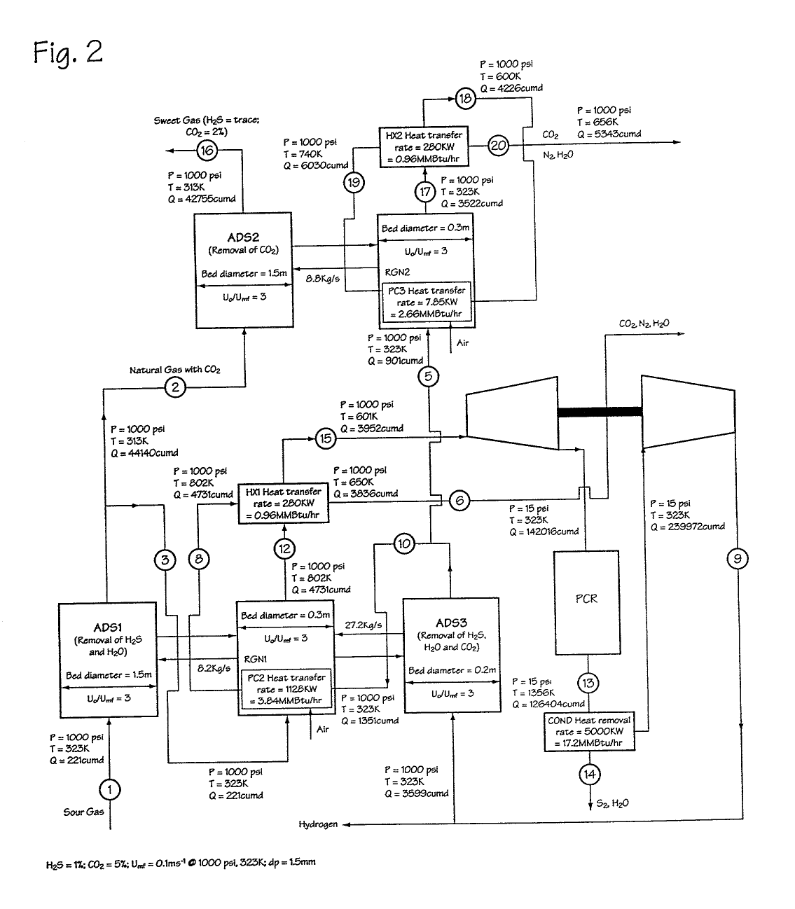

Referring now to FIG. 2, the processes of sweetening sour gas and recovery of sulfur and hydrogen are integrated into a single compact process, as described below. First, the sour natural gas stream is contacted with the adsorbent (such as a molecular sieve 5A) in a fluidized bed adsorber, designated as ADS1 in FIG. 2, to effect the removal of H₂S, H₂O, and other sulfur-containing contaminants. The partially sweetened natural gas stream is then passed through a second fluidized bed adsorber, designated as ADS2, where CO₂ is stripped, also, using the molecular sieve 5A as an adsorbent. Though, in principle, H₂S, CO₂, H₂O, and other sulfur-containing contaminants can all be removed from the natural gas stream by the molecular sieve 5A in a single adsorber unit, two separate units become necessary for maximizing the process efficiency for sulfur recovery.

The sequential stripping of H₂S and H₂O in ADS1 followed by removal of CO₂ in ADS2 is made possible by the well-defined sequence in which these species are adsorbed on the molecular sieve. The residence time and the circulation rates of solids, then will be controlled so that the species adsorbed in ADS1 are primarily H₂S and H₂O.

At a high operating pressure (e.g., 1000 psig), the fluidized bed adsorber units can be operated in a bubbling bed mode. Calculations show that these adsorber units can be very compact units, approximately thirty (30″) inches in diameter for an eleven (11) MMScfd plant. Existing molecular sieve-based processes employ fixed beds in view of the possibility of sorbent attrition. The bubbling bed mode of operation (at about three (3) times the minimum fluidization velocity, with a minimum fluidization velocity of approximately thirty-three (33 fps) feet per second at one thousand (1000) psig and three hundred (300°) degrees K for molecular sieves with an average particle diameter of approximately 0.06 inch) reduces the risk of attrition. In addition, a material, such as molybdenum sulfide, PTFE, graphite, among others, with a low coefficient of friction will be added to the bed in very small quantities to further reduce the potential for attrition.

The spent sorbent from the adsorber units is then pneumatically transported to the regeneration units. Regenerators are also operated in the bubbling fluidized bed mode; the temperature of operation is about four hundred and forty (440°) degrees F. The molecular sieve adsorbent from ADS1 is regenerated, with release of H₂S and H₂O, in RGN1. This unit is maintained in the bubbling fluidized bed mode using a slip stream from the partially-sweetened natural gas. Calculations show that about 0.5 (%) percent of the natural gas stream will suffice to maintain the operation of RGN1. The mixture of H₂S, H₂O, and natural gas recovered from RGN1 is used for the downstream recovery of elemental sulfur and hydrogen. Spent sorbent from ADS2 is regenerated, with release of CO₂, in RGN2. The regenerated solids are recirculated into the adsorber units. The ease of sorbent transportation between adsorber and regeneration units is a key advantage of the process of the present invention (in comparison with other fixed dry bed processes) made possible by the use of the fluidized bed mode of operation.

The sorbent recirculation rates are determined by the amount of contaminants in the natural gas. Conventionally, gas-conditioning processes employing molecular sieves are based on fixed bed technology. Cooling and heating of beds to serve as adsorbers or regenerators requires time. The temperature swing adsorption then limits the region of operability to low H₂S concentrations in medium scale operation. The ability to alter, with ease, the flow rate of solids within the adsorber and regenerator units through operation in the fluidized bed mode provides the process flexibility of operation in the handling of different compositions and greatly enhances the possible regime of operation in terms of H₂S concentrations as well as processing scale. Since molecular sieves have a high surface area and, therefore, large adsorption capacities, the recirculation rate of solids is kept at a minimum, providing a compact design.

Energy is required to maintain the adsorber/regenerator loops operated on the principle of temperature swing adsorption. The energy to maintain the beds at four hundred and forty (440°) degrees F. is supplied by combustion of gases in a pulse combustor, designated as PC2 and PC3 in FIG. 2, immersed within the gently bubbling fluidized beds. The submerged pulse combustors behave as submerged tubes and therefore deliver the well-known advantage of high heat transfer coefficients (thirty-five (35) to seventy (70) BTU hr⁻¹ft⁻²°F.⁻¹) between the bed and the tubes. These heat transfer coefficients are higher by, at least one order of magnitude in comparison with those obtained from a tube immersed in convective flow of a gas. The higher heat transfer coefficients make possible use of a lower surface area for heat exchange for the same temperature differences and heat duty resulting in a compact design fro the regenerator units. The mixing of solids within the bubbling bed ensures that the bed temperature is uniform. The fuel gas for the pulse combustors PC2 and PC3 submerged, respectively, in RGN1 and RGN2, is derived from the synthesis gas (CO and H₂) generated in the corona reactor.

In a corona reactor, extremely reactive species, such as radicals and excited molecules are generated at ambient temperature without the presence of catalysts. Also, little energy is lost due to heating of the gas as compared with thermal processes.

The gas mixture, consisting of H₂S and H₂O released from the molecular sieves and natural gas used as the fluidization medium, from RGN1 is used for recovery of elemental sulfur and hydrogen. This recovery is effected in a pulsed corona reactor designated as PCR in FIG. 2. The gas mixture consisting of H₂S, H₂O, CH₄, and CO₂, following expansion, is introduced into the pulsed corona reactor where the following reactions take place:

H₂S⇄H₂+S (11)

H₂S+CO₂⇄CO+H₂O+S (10)

CH₄+CO₂→2H₂+2CO (12)

CH₄+2H₂S→CS₂+4H₂ (13)

CO₂+H₂←→CO+H₂O (14)

2H₂S+2CO →2H₂+2COS (15)

2COS+SO₂→2CO₂+3/2S₂ (16)

CS₂+SO₂→CO₂+3/2S₂ (17).

The efficiency of sulfur recovery according to the present invention depends primarily on minimizing formation of CS₂ and COS in the corona reactor. By adjusting the amount of excess CO₂, i.e., the H₂S/CO₂ and CH₄/CO₂ ratios, complete conversion of H₂S and CH₄ is possible. Thus, in a nonthermal plasma reactor, H₂S conversion exceeding ninety-nine (99%) percent is possible.

The gases exiting from the corona reactor consist, mainly, of unconverted H₂S, CH₄, and CO₂, H₂O, elemental sulfur species Sᵢ with I=1 to 8, CO, H₂, CS₂ and COS. These gases are quenched, in a condenser designated as COND in FIG. 2, to remove elemental sulfur and water. The remaining gases—H₂S, CH₄, CO₂, CO, H₂, CS₂, and COS—are compressed back to system pressure (1000 psig for the example considered) before flowing through an adsorption unit, designated as ADS3 in FIG. 2, where the gases also serve as the fluidizing medium for the bubbling bed. The adsorption unit removes H₂S and CO₂ from the gas stream using the molecular sieve 5A. The spent sorbent from the adsorber unit is regenerated in RGN1 so that the unconverted H₂S is recycled to the sulfur and hydrogen recovery pulsed corona reactor. The gases from ADS3, consisting of CH₄, CO, H₂, and COS, are passed through a hydrogen separation unit. The rest of the gas mixture is fired in pulse combustors PC2 and PC3, which provide the energy required to maintain the regenerators RGN1 and RGN2 at the temperature of four hundred and forty (440°) degrees F. It should be noted that a fraction of the gas stream exiting the hydrogen separator is used for fluidization of RGN2 after which the gases are fired in PC3. The off-gases from PC2 and PC3, following heat recovery, are vented.

In comparison with some of the existing processes, there are several advantages offered by the process configuration of the present invention including, but not limited to, recovery of elemental sulfur and hydrogen, smaller size and lower costs, energy efficiency, flexibility of operation for treatment of sour gas and Claus reactor effluent streams with varying H₂S levels, etc.

First, concerning the recovery of elemental sulfur and hydrogen, the off-gas from the regenerator is sent to the flare in conventional fixed bed processes. In the system and process according to the present application, both elemental sulfur and hydrogen are recovered from H₂S in the sour gas.

Second, the system and process according to the present invention provides smaller size and lower costs. Conventional technology employs fixed bed adsorption/regeneration columns such that when the adsorber column gets exhausted, flow of “sour” gas is diverted to another adsorber column. The exhausted adsorber column is then regenerated by passage of hot gas. After regeneration, this column has to be cooled to the temperatures at which the molecular sieves will adsorb the contaminants again. Since the cooling of the bed takes time, conventional processes often require three (3) or four (4) columns. In the system and process of the present application, regenerated sorbent is recycled continuously. In addition, the thermal inertia and the excellent mixing characteristics in the two legs of the recirculating bed ensure that the temperatures are maintained at the levels required. Consequently, only two columns will be necessary.

Third, the system and process according to the present invention provides energy efficiency. In conventional processes, the energy required to raise the temperature of the molecular sieves to strip the contaminants is provided by combustion of a natural gas stream in a separate burner. The off-gases from the regenerator are sent to the flare. In this process, the synthesis gas generated from H₂S in the corona reactor is burnt in pulse combustors and the regenerator is heated through the pulse combustors acting as immersed heat transfer tubes. Thus, the process makes use of the high heat transfer coefficients provided by submerged tubes in a fluidized bed. Also, the energy required to raise the bed temperature is obtained, indirectly, from H₂S.

Finally, the system and process of the present application provides flexibility of operation. The sorbent recirculation rate can be adjusted to meet different levels of contamination in the natural gas. Calculations show that the process can sweeten sour gas of the composition (one (1%) percent H₂S) with sulfur recovery of ninety-nine (99%) percent. The operating conditions identified by the thermodynamic calculations—in terms of higher H₂S/CO₂ ratios aiding higher sulfur recovery—suggest that the proposed process can be used to advantage for conditioning of gas streams with higher H₂S contents. Conventionally, gas-conditioning processes employing molecular sieves are based on fixed bed technology. Cooling and heating of beds to serve as adsorbers or regenerators requires time. The temperature swing adsorption then limits the region of operability to low H₂S concentrations in medium scale operations. The ability to alter, with ease, the flow rate of solids within the adsorber and regenerator units through handling of different compositions and greatly enhances the possible regime of operation in terms of H₂S concentrations as well as processing scale.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

We claim:

1. A device for removing contaminants from a natural gas stream, the device comprising:
first adsorbent means positioned within a first fluidized bed operating at a first predetermined temperature for removing at least a portion of the contaminants from the natural gas stream and creating a partially sweetened natural gas stream; and
second adsorbent means positioned within a second fluidized bed operating at a second predetermined temperature for receiving the partially sweetened natural gas stream, the second adsorbent means removing at least a portion of the contaminants from the partially sweetened natural gas stream.

2. The device of claim 1 wherein the contaminants are selected from the group consisting of H₂S, CO₂, and H₂O.

3. The device of claim 1 wherein the first adsorbent means is a molecular sieve.

4. The device of claim 1 wherein the second adsorbent means is a molecular sieve.

5. The device of claim 1 wherein the first predetermined temperature is greater than the second predetermined temperature.

6. The device of claim 1 wherein the first predetermined temperature is between approximately twenty (20°) degrees C. and approximately sixty (60°) degrees C.

7. The device of claim 6 wherein the first predetermined temperature is approximately twenty-five (25°) degrees C.

8. The device of claim 1 wherein the second predetermined temperature is between approximately one hundred (100°) degrees C. and approximately three hundred (300°) degrees C.

9. The device of claim 2 wherein the second predetermined temperature is approximately two hundred (200°) degrees C.

10. The device of claim 1 and further comprising:
conversion means for converting H₂S within the removed contaminants to elemental sulfur and hydrogen at a predetermined temperature less than approximately four hundred (400°) degrees C.

11. The device of claim 10 wherein the conversion mean is a nonthermal plasma corona reactor.

12. An apparatus for converting H₂S to elemental sulfur and hydrogen, the apparatus comprising:
conversion means for receiving H₂S and for converting H₂S to elemental sulfur and hydrogen at a predetermined temperature less than approximately four hundred (400°) degrees C.

13. The apparatus of claim 12 wherein the conversion means is a nonthermal plasma corona reactor.

14. The apparatus of claim 12 and further comprising:
adsorbent means positioned within a fluidized bed for removing at least a portion of H₂S from a natural gas stream; and
means for providing the removed H₂S to the conversion means.

15. The apparatus of claim 14 wherein the adsorbent means includes a first adsorbent having a first predetermined temperature and second adsorbent having a second predetermined temperature.

16. The apparatus of claim 15 wherein the first adsorbent means and the second adsorbent means are a molecular sieves.

17. The apparatus of claim 15 wherein the first predetermined temperature is greater than the second predetermined temperature.

18. A method for removing H₂S and other contaminants from a natural gas stream and converting H₂S to elemental sulfur and hydrogen, the method comprising:
providing first adsorbent means;
positioning the first adsorbent means within a fluidized bed at a first predetermined temperature;
introducing the natural gas stream to the first adsorbent means thereby removing at least a portion of the H₂S and other contaminants from the natural gas stream and creating a partially sweetened natural gas stream;
providing second adsorbent means;
positioning the second adsorbent means within a fluidized bed at a second predetermined temperature;
introducing the partially sweetened natural gas stream to the second adsorbent means thereby removing at least a portion of the contaminants from the partially sweetened natural gas stream;
providing a nonthermal plasma reactor;
introducing the removed contaminants to the nonthermal plasma reactor; and
converting the H₂S to elemental sulfur and hydrogen at a third predetermined temperature.

19. The method of claim 18 wherein the first adsorbent means and the second absorbent means are molecular sieves.

20. The method of claim 18 wherein the first predetermined temperature being greater than the second predetermined temperature.

21. The method of claim 18 wherein the first predetermined temperature being between approximately twenty (20°) degrees C. and approximately sixty (60°) degrees C.

22. The method of claim 18 wherein the second predetermined temperature being between approximately one hundred (100°) degrees C. and appropriately three hundred (300°) degrees C.

23. The method of claim 18 wherein the third predetermined temperature being less than approximately four hundred (400°) degrees C.
